(19) United States
(12) Patent Application Publication
(10) Pub. No.: US 2008/0278465 A1
(43) Pub. Date: Nov. 13, 2008

(54) DOT CLOCK GENERATING CIRCUIT, SEMICONDUCTOR DEVICE, AND DOT CLOCK GENERATING METHOD

(75) Inventor: Takashi Katou, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 12/100,145

(22) Filed: Apr. 9, 2008

(30) Foreign Application Priority Data
May 7, 2007 (JP) 2007-122601

(51) Int. Cl. G09G 5/12

(52) U.S. Cl. 345/204

(57) ABSTRACT

A dot clock generating circuit includes a division ratio holding unit to hold division ratio information specifying a clock division ratio and to output the division ratio information synchronously with switching of frames and a clock generator to divide the frequency of a reference clock according to the division ratio information output from the division ratio holding unit, thereby generating a dot clock.

### BACKGROUND OF THE INVENTION

1. Field of the Invention

The present invention relates to a circuit for generating a dot clock that is a reference clock for use when a display device displays in dots.

2. Description of Related Art

Recently, there have been display devices which switch display between multiple images different in resolution. Such a display device switches its resolution according to an instruction from a user or through between-device communication. At this time, the display device needs to switch the dot clock for controlling display timing.

A plurality of dot clock switching methods have been implemented and proposed. One method is to use a clock generating circuit having a PLL (Phase Locked Loop) incorporated therein to switch the PLL division ratio. With this method, a switch to a desired clock frequency does not occur immediately after changing the division ratio, but there exists a time period of several tens to several hundred msec during which the clock frequency is unstable. In that time period, a normal image cannot be displayed. Hence, usually, the display device is configured to display no image in that time period. Herein, the time period during which no image is displayed is called a frame non-display period for convenience. Techniques to resolve the problem of the unstable clock frequency time period are described in, e.g., Japanese Unexamined Patent Application Publications No. S64-73386 and No. H02-251890.

However, even if the problem of the unstable clock frequency time period is resolved, it is not ensured that the dot clock switching occurs at the beginning of a frame. Further, the possibility that the dot clock switching may occur while a frame is being displayed is high, for which frame a normal image cannot be displayed. Hence, the time period from switching the clock frequency until displaying the beginning of a frame is often set as the frame non-display period.

Accordingly, we hove now discovered that there is needed a clock generating circuit which realizes a display device that displays images without a frame non-display period when switching its resolution.

### SUMMARY

According to one aspect of the present invention, there is provided a dot clock generating circuit including a division ratio holding unit to hold division ratio information specifying a clock division ratio and to output the division ratio information synchronously with switching of frames; and a clock generator to divide the frequency of a reference clock according to the division ratio information output from the division ratio holding unit, thereby generating a dot clock.

According to another aspect of the present invention, there is also provided a semiconductor device including the dot clock generating circuit, and a control circuit to detect a timing to change a dot clock frequency and to output division ratio information to the dot clock generating circuit.

According to further aspect of the present invention, there is provided a dot clock generating method including holding division ratio information specifying a clock division ratio, outputting the division ratio information held synchronously with switching of frames, and generating a dot clock having a clock frequency changed according to the division ratio information output.

According to the present invention, it is possible to provide a clock generating circuit which realizes a display device that displays images without a frame non-display period when switching its resolution.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing an example configuration of a dot clock generating circuit according to Embodiment 1 of the present invention;

FIG. 2 is a block diagram showing an example configuration of a display device using the dot clock generating circuit of FIG. 1;

FIG. 3 is a timing chart showing an example operation of the dot clock generating circuit of Embodiment 1;

FIG. 4 is a block diagram showing an example configuration of a dot clock generating circuit according to Embodiment 2 of the present invention; and

FIG. 5 is a timing chart showing an example operation of the dot clock generating circuit of Embodiment 2.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be described below with reference to the drawings. For clarification, omission and simplification are made as needed in the description below and the drawings. In the drawings, components and corresponding parts having the same configurations or functions are denoted by the same reference numerals, with duplicate description thereof being omitted.

### Embodiment 1

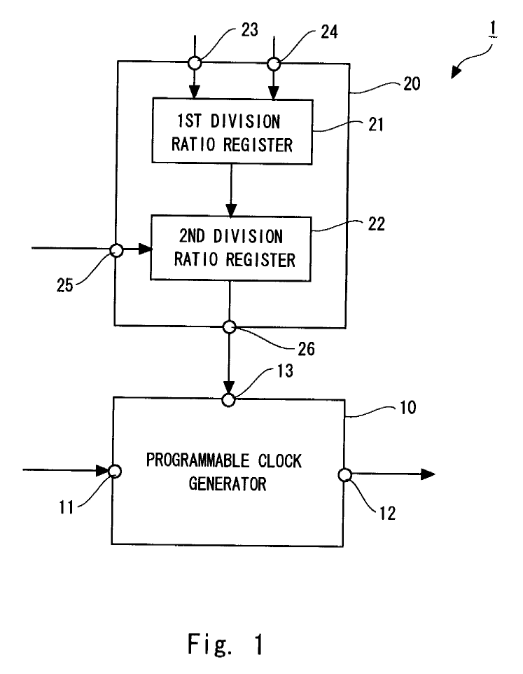

FIG. 1 is a block diagram showing an example configuration of a dot clock generating circuit according to Embodiment 1 of the present invention. A dot clock generating circuit (dot clock generating device) 1 shown in FIG. 1 includes a programmable clock generator (clock generator) 10 and a clock division ratio holding unit (division ratio holding unit) 20.

The programmable clock generator 10 outputs a dot clock produced by dividing the frequency of a reference clock through an output terminal 12. Further, the programmable clock generator 10 can switch its division ratio according to a clock division ratio (division ratio information) input through an input terminal 13. Yet further, the programmable clock generator 10 does not produce an unstable clock time period when switching its division ratio. There are various techniques to prevent an unstable clock time period from being produced such as the one described in Japanese Unexamined Patent Application Publication No. S64-73386, and any of the techniques can be used herein.

An input terminal (reference clock input terminal) 11 has the reference clock inputted thereto.

The output terminal (dot clock output terminal) 12 outputs a dot clock produced by dividing the frequency of the reference clock according to the division ratio.

The input terminal (clock division ratio input terminal) 13 has inputted thereto the division ratio information specifying the clock division ratio.

The division ratio information need only be information which specifies (identifies) a clock division ratio so that the programmable clock generator 10 can select it and may be the value of a clock division ratio, a flag indicating a predetermined clock division ratio, or the like. For example, a technique may be used where a plurality of prescribed clock division ratios are stored such that a flag is associated with each clock division ratio and where the division ratio information specifies one of the flags. In the description below, the case where the division ratio information is a clock division ratio will be described.

The clock division ratio holding unit 20 includes a first division ratio register (first clock division ratio register) 21 and a second division ratio register (second clock division ratio register) 22.

The first division ratio register (first register) 21 holds the division ratio information to be set.

The second division ratio register (second register) 22 holds the division ratio information having been held in the first division ratio register upon the timing of switching frames.

An input terminal (first write valid signal input terminal) 23 has inputted thereto a write valid signal to enable writing data into the first division ratio register 21.

An input terminal (write data input terminal) 24 has inputted thereto data to be written into the first division ratio register 21.

An input terminal (second write valid signal input terminal) 25 has inputted thereto a write valid signal to enable writing data into the second division ratio register 22.

The output terminal (clock division ratio output terminal) 26 outputs a clock division ratio.

When the write valid signal is input to the input terminal 25, the output value of the first division ratio register 21 is input to the second division ratio register 22. A signal from which the switching of frames can be detected, preferably for example, a vertical synchronization signal is used as the write valid signal.

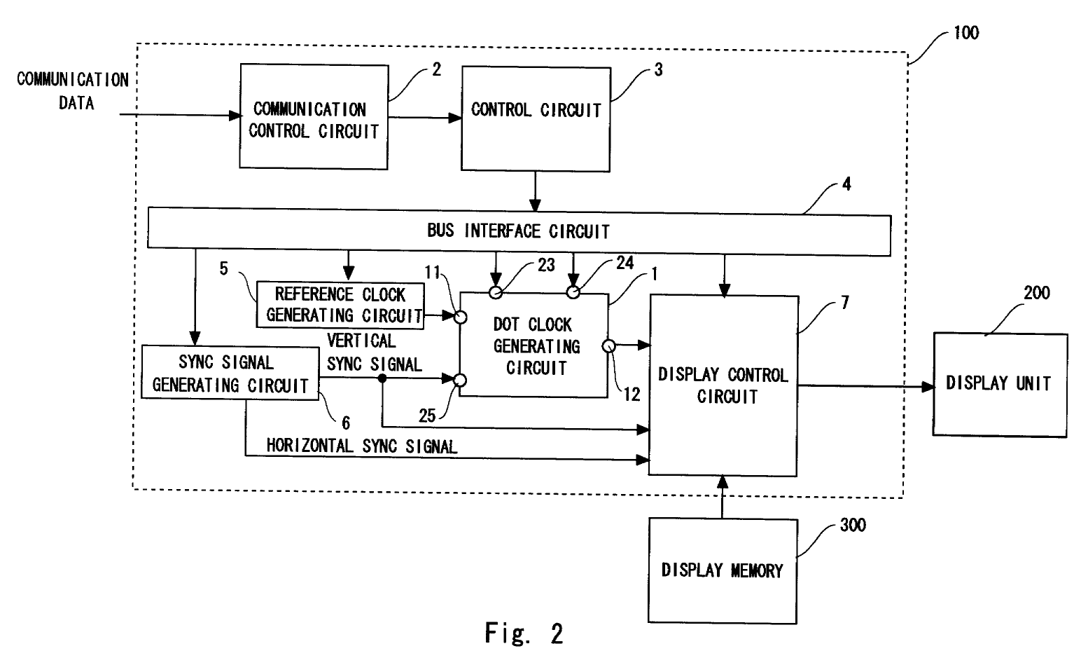

Next, an example configuration of a display device using the dot clock generating circuit 1 of FIG. 1 will be described. FIG. 2 is a block diagram showing an example configuration of a display device using the dot clock generating circuit 1 of FIG. 1. The display device of FIG. 2 includes a display controller (semiconductor device) 100, a display unit 200, and a display memory 300. In FIG. 2, the input and output terminals of the dot clock generating circuit 1 are shown with terminals of the other circuits being omitted.

The display controller 100 includes a function to control display data. The display controller 100 includes the dot clock generating circuit 1 of FIG. 1, a communication control circuit 2, a control circuit (central control circuit) 3, a bus interface circuit 4, a reference clock generating circuit 5, a synchronization signal generating circuit 6, and a display control circuit 7.

The display unit 200 displays a video signal output from the display controller 100. For example, a CRT (Cathode Ray Tube), an LCD (Liquid Crystal Display), a PDP (Plasma Display Panel), or the like is used as the display unit.

The display memory 300 stores display data to be displayed on the display unit 200.

The communication control circuit 2 has communication data inputted thereto and outputs the data to the control circuit 3. The communication control circuit 2 notifies, e.g., a user's instruction to switch display screens to the control circuit 3. At this time, if resolution needs to be changed, a resolution to be changed to is also notified.

The control circuit 3 notifies other circuits of instructions to process and data based on an instruction input from the communication control circuit 2. The control circuit 3 is embodied by, e.g., a CPU (Central Processing Unit).

The bus interface circuit 4 sets the instructions from the control circuit 3 in circuits downstream thereof. In the present embodiment, the control circuit 3 detects a timing at which to change resolution and outputs the clock division ratio corresponding to the resolution to which to change, to the dot clock generating circuit 1 via the bus interface circuit 4.

The reference clock generating circuit 5 outputs the reference clock to the input terminal 11.

The synchronization signal generating circuit 6 outputs a horizontal synchronization signal or a vertical synchronization signal to the display control circuit 7. Also, the synchronization signal generating circuit 6 outputs the vertical synchronization signal to the input terminal 25.

The display control circuit 7 reads display data from the display memory 300 and outputs a video signal to the display unit 200 synchronously with the dot clock and the synchronization signals (horizontal and vertical synchronization signals).

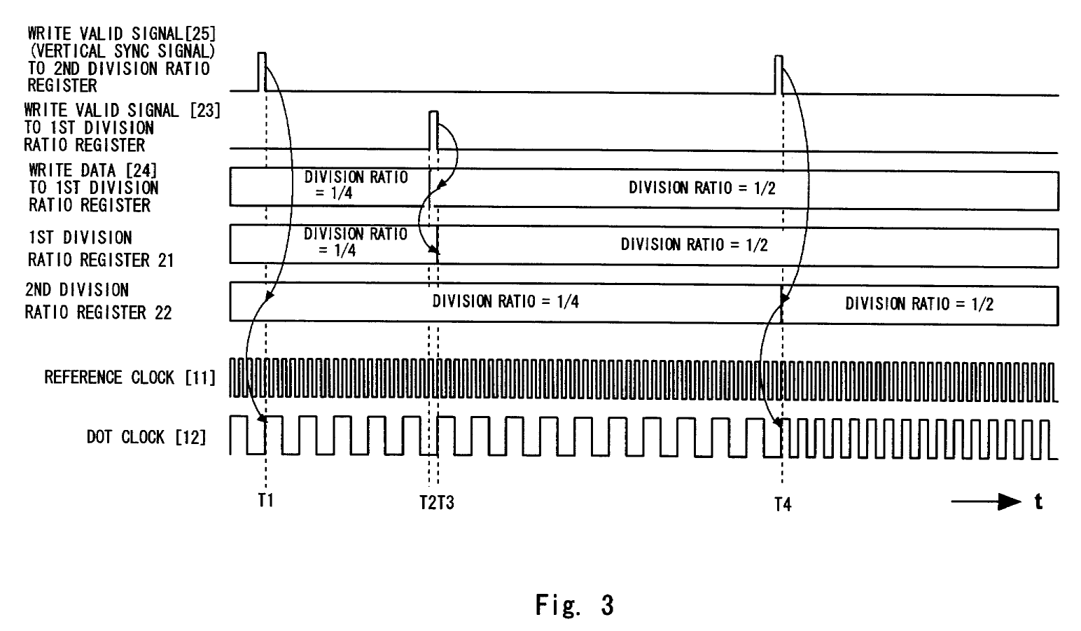

Next, the operation of the dot clock generating circuit 1 of the present embodiment will be described using FIG. 3. FIG. 3 is a timing chart showing an example operation of the dot clock generating circuit 1 of the present embodiment. The numerical values in the Figure are illustrative, and these quantities are not intended to be limited to these values. T1 to T4 indicate timings. Numerals in square brackets added to the ends of signal names on the left are the reference numerals of signal input and output terminals and the same as corresponding reference numerals in FIG. 1. FIG. 3 shows the case where an instruction to switch the dot clock occurs at time T2.

The programmable clock generator 10 divides the reference clock frequency according to the clock division ratio input through the clock division ratio input terminal 13 (T1). The programmable clock generator 10 outputs the frequency-divided dot clock onto the dot clock output terminal 12. Note that in this example, at timing T1 the division ratio is not changed, although frames are switched.

For example, the control circuit 3 of the display device recognizes a resolution switch instruction (dot clock switch instruction) from a user or the like (T2). The control circuit 3 inputs a changed clock division ratio to the input terminal 24 in response to the dot clock switch instruction and inputs the write valid signal (a write pulse) to the write valid signal input terminal 23 (T2). At the next rise timing (T3) of the reference clock, the content of the first division ratio register 21 is replaced with the changed clock division ratio specified through the input terminal 24.

Then, when a signal from which the switching of frames can be recognized, preferably, the vertical synchronization signal pulse is input to the input terminal 25, the content of the first division ratio register 21 is written into the second division ratio register 22 (T4). When the content of the second division ratio register 22 is replaced, the value on the clock division ratio input terminal 13 changes via the clock division ratio output terminal 26, and thus the dot clock on the dot clock output terminal 12 switches in frequency.

As such, by using the dot clock generating circuit 1 of the present embodiment, the dot clock can be switched synchronously with the frame switching. By this means, without providing the frame non-display period, a display device of which the display image is not disturbed when switching its resolution can be realized.

Specifically, the programmable clock generator 10 has a function to switch the clock frequency without producing an unstable clock time period. By this means, with the dot clock generating circuit 1 of the present embodiment, the frame non-display period associated with switching the clock frequency is reduced. Moreover, the clock division ratio holding unit 20 outputs a clock division ratio synchronously with the frame switching, and at this timing, the programmable clock generator 10 reads in the clock division ratio and switches the clock frequency. By this means, the dot clock generating circuit 1 of the present embodiment can prevent switching the dot clock while a frame is being displayed, and the dot clock is switched at the beginning of a frame. In this way, the frame non-display period can be reduced as compared to the prior art.

### Embodiment 2

In Embodiment 2, an implementation will be described wherein a function to adjust timings at which to change the clock frequency is added to the dot clock generating circuit of Embodiment 1.

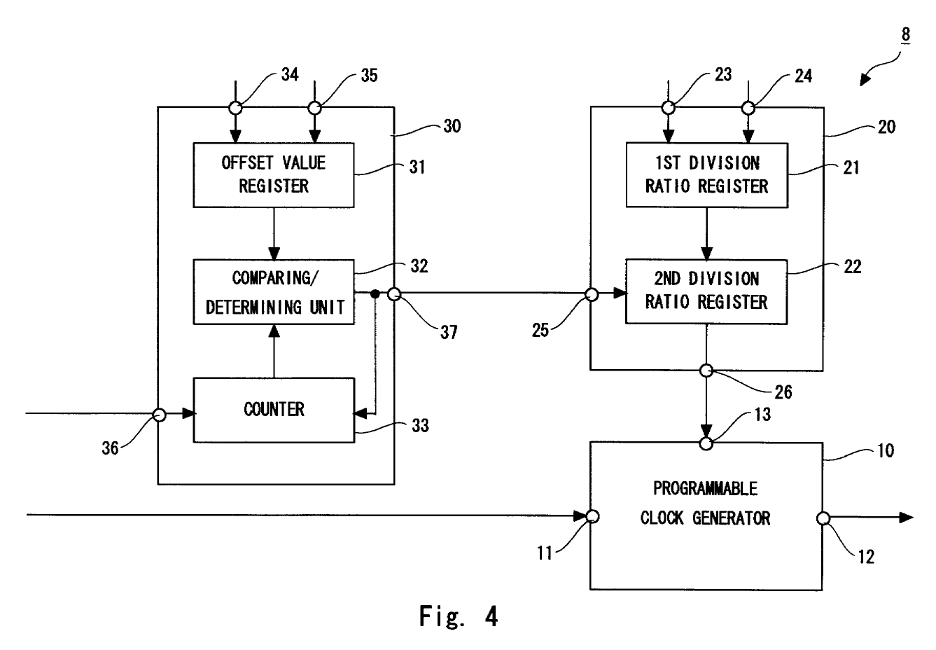

FIG. 4 is a block diagram showing an example configuration of a dot clock generating circuit according to Embodiment 2 of the present invention. The dot clock generating circuit 8 of FIG. 4 is configured with the dot clock generating circuit 1 of Embodiment 1 having a clock division ratio switch timing adjusting unit (adjusting unit) 30 added thereto.

The clock division ratio switch timing adjusting unit 30 includes an offset value register 31, a comparing/determining unit 32, and a counter 33.

The offset value register 31 holds an offset value (a time) by which to delay the timing to change the clock frequency.

The comparing/determining unit 32 compares the offset value and the count value of the counter 33 and if they equal, outputs the write valid signal to the input terminal 25 via the output terminal 37.

The input terminal 34 has inputted thereto a write valid signal to enable writing data into the offset value register 31.

The input terminal 35 has inputted thereto data to be written into the offset value register 31.

The input terminal 36 has inputted thereto a counter start signal to instruct the counter 33 to start counting up.

The output terminal 37 outputs a write valid signal to enable writing data into the second division ratio register 22.

The input terminal 25 of the clock division ratio holding unit 20 has inputted thereto the write valid signal output through the output terminal 37.

Note that the dot clock generating circuit 8 of the present embodiment can be incorporated in the display controller 100 instead of the dot clock generating circuit 1 (not shown). In this case, the input terminals of the dot clock generating circuit 1 shown in FIG. 2 are changed as follows. The input terminals 34, 35 are added and the input terminal 36 is placed instead of the input terminal 25. In the description below, the case where the dot clock generating circuit 8 operates in the display device of FIG. 2 will be described as an example.

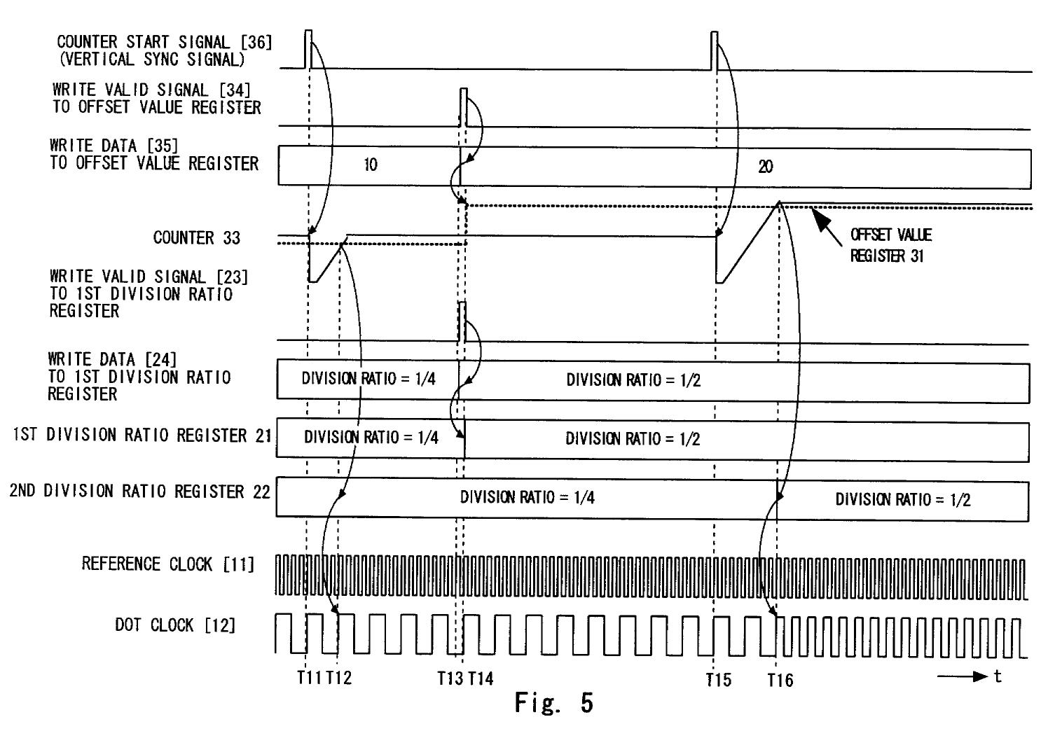

The operation of the dot clock generating circuit 8 of the present embodiment will be described below using FIG. 5. FIG. 5 is a timing chart showing an example operation of the dot clock generating circuit 8 of the present embodiment. The numerical values in the Figure are illustrative, and these quantities are not intended to be limited to these values. T11 to T16 indicate timings. Numerals in square brackets added to the ends of signal names on the left are the reference numerals of signal input and output terminals and the same as corresponding reference numerals in FIG. 4. FIG. 5 shows the case where an instruction to switch the dot clock occurs at time T13.

When a counter start signal, preferably, the vertical synchronization signal pulse is input to the input terminal 36, the counter 33 is zero cleared and starts counting up (T11). The comparing/determining unit 32 compares the output value of the offset value register 31 and the output value of the counter 33, and if it is determined that they equal (T12), the programmable clock generator 10 divides the reference clock frequency according to the clock division ratio input through the clock division ratio input terminal 13 and outputs the dot clock onto the dot clock output terminal 12. Note that in this example, at timing T12 the division ratio is not changed, although frames are switched. The operation of the clock division ratio switch timing adjusting unit 30 will be described in detail in the description of time T16.

For example, the control circuit 3 of the display device recognizes a resolution switch instruction (dot clock switch instruction) from a user or the like (T13). The control circuit 3 inputs a changed clock division ratio to the input terminal 24 in response to the dot clock switch instruction and inputs a write pulse to the input terminal 23 (T13). At the next rise timing (T14) of the reference clock, the content of the first division ratio register 21 is replaced with the changed clock division ratio specified through the input terminal 24.

In the case where in the clock division ratio switch timing adjusting unit 30, the content of the offset value register 31 is changed in response to the dot clock switch instruction, the control circuit 3 inputs a changed offset value to the input terminal 35 and a write pulse to the input terminal 34 (T13). At the next rise timing (T14) of the reference clock, the content of the offset value register 31 is replaced with the changed offset value specified through the input terminal 35.

Then, when a signal from which the switching of frames can be recognized, preferably, the vertical synchronization signal pulse is input to the input terminal 36, the counter 33 is zero cleared and starts counting up. The comparing/determining unit 32 compares the output value of the offset value register 31 and the output value of the counter 33 and, if it is determined that they equal (T16), generates a write valid signal pulse for the second division ratio register 22. The write valid signal causes the counter 33 to stop counting.

The write valid signal is output through the output terminal 37 to the input terminal 25, and the content of the first division ratio register 21 is written into the second division ratio register 22. When the content of the second division ratio register 22 changes, the value of the clock division ratio output through the output terminal 26 to the input terminal 13 changes. As a result, the programmable clock generator 10 changes the clock frequency according to the clock division ratio and switches the dot clock, which is output through the output terminal 12. As such, at time T16 that is later by the offset value than time T15, the dot clock is switched.

In this way, by using the dot clock generating circuit 8 of the present embodiment, the time period from the frame switching to the dot clock switching can be adjusted, in addition to the effect of Embodiment 1. By this means, the timing to change resolution can be adjusted corresponding to the function of the display device.

The display device shown in FIG. 2 is merely an example, and the dot clock generating circuits 1, 8 of the above embodiments can be applied to any display device requiring the dot clock, not being limited to the display device of the configuration shown in FIG. 2. Further, the configuration of the display controller (semiconductor device) 100 of FIG. 2 is merely an example, and the configuration thereof is not limited to this. Semiconductor devices having the dot clock generating circuit 1 or 8 incorporated therein need only be configured to have at least the control circuit 3. Yet further, in the above embodiments, there has been described the case where the control circuit 3 outputs the dot clock switch instruction and the synchronization signal generating circuit 6 outputs the signal from which to detect frame switching (the vertical synchronization signal), but the present invention is not limited to this. The dot clock generating circuits 1, 8 may operate according to a dot clock switch instruction and a signal from which to detect frame switching which come from the outside.

The clock generating circuits of the above embodiments can be applied to display devices in general.

According to the preferred embodiments of the present invention, as described above, the clock frequency can be switched, and there can be provided the dot clock generating circuit including clock generating means (e.g., the programmable clock generator 10 of FIG. 1) which does not produce an unstable clock time period when switching the clock frequency and means to instruct the clock generating means to switch the clock frequency synchronously with the frame switching (e.g., the clock division ratio holding unit 20 of FIG. 1). By this means, the dot clock can be switched synchronously with the frame switching, and hence the frame non-display period need not be provided. Moreover, a display device of which the display image is not disturbed when switching its resolution can be realized.

Furthermore, by providing means to adjust timings to change the clock frequency, timings to switch the dot clock can be adjusted.

The present invention is not intended to be limited to the above embodiments. It is to be understood by those skilled in the art that modifications, additions and alterations can be made to elements of the embodiments within the scope of the present invention.

It is apparent that the present invention is not limited to the above embodiments, but may be modified and changed without departing from the scope and spirit of the invention.

What is claimed is:

1. A dot clock generating circuit comprising:
a division ratio holding unit to hold division ratio information specifying a clock division ratio and to output the division ratio information synchronously with switching of frames; and
a clock generator to divide the frequency of a reference clock according to the division ratio information output from the division ratio holding unit, so as to generate a dot clock.

2. The dot clock generating circuit according to claim 1, wherein the division ratio holding unit detects the switching of frames based on a vertical synchronization signal.

3. The dot clock generating circuit according to claim 1, wherein the division ratio holding unit comprises:
a first register to hold the division ratio information to be set; and
a second register to hold the division ratio information having been held in the first register upon the frame switching and to output the division ratio information held therein to the clock generator.

4. The dot clock generating circuit according to claim 2, wherein the division ratio holding unit comprises:
a first register to hold the division ratio information to be set; and
a second register to hold the division ratio information having been held in the first register upon the frame switching and to output the division ratio information held therein to the clock generator.

5. The dot clock generating circuit according to claim 1, wherein the clock generator switches the frequency of the dot clock according to the division ratio information without producing a time period while the dot clock frequency is unstable.

6. The dot clock generating circuit according to claim 2, wherein the clock generator switches the frequency of the dot clock according to the division ratio information without producing a time period while the dot clock frequency is unstable.

7. The dot clock generating circuit according to claim 3, wherein the clock generator switches the frequency of the dot clock according to the division ratio information without producing a time period while the dot clock frequency is unstable.

8. The dot clock generating circuit according to claim 1, further comprising:
an adjusting unit to adjust a time from detection of the frame switching to a timing to output the division ratio information by the division ratio holding unit,
wherein the division ratio holding unit outputs the division ratio information to the clock generator upon the timing adjusted by the adjusting unit.

9. The dot clock generating circuit according to claim 2, further comprising:
an adjusting unit to adjust a time from detection of the frame switching to a timing to output the division ratio information by the division ratio holding unit,
wherein the division ratio holding unit outputs the division ratio information to the clock generator upon the timing adjusted by the adjusting unit.

10. The dot clock generating circuit according to claim 3, further comprising:
an adjusting unit to adjust a time from detection of the frame switching to a timing to output the division ratio information by the division ratio holding unit,
wherein the division ratio holding unit outputs the division ratio information to the clock generator upon the timing adjusted by the adjusting unit.

11. The dot clock generating circuit according to claim 4, further comprising:
an adjusting unit to adjust a time from detection of the frame switching to a timing to output the division ratio information by the division ratio holding unit,
wherein the division ratio holding unit outputs the division ratio information to the clock generator upon the timing adjusted by the adjusting unit.

12. A semiconductor device, comprising:
a dot clock generating circuit according to claim 1; and
a control circuit to detect a timing to change a dot clock frequency and to output division ratio information to the dot clock generating circuit.

13. A dot clock generating method comprising:
holding division ratio information specifying a clock division ratio;
outputting the division ratio information held synchronously with switching of frames; and
generating a dot clock having a clock frequency changed according to the division ratio information output.
